(19) United States
(12) Patent Application Publication
(10) Pub. No.: US 2017/0196776 A1
(43) Pub. Date: Jul. 13, 2017

(54) Absorbent Neck Ring for a Baby Bottle

(71) Applicant: DeeAnna Marek, Brenham, TX (US)

(72) Inventor: DeeAnna Marek, Brenham, TX (US)

(21) Appl. No.: 15/411,920

(22) Filed: Jan. 20, 2017

Related U.S. Application Data
(63) Continuation-in-part of application No. 14/535,727, filed on Nov. 7, 2014, now abandoned.
(60) Provisional application No. 61/901,636, filed on Nov. 8, 2013.

(51) Int. Cl. A61J 11/00; B67B 3/20; A23L 33/00; A61J 9/00

(52) U.S. Cl. CPC A61J 11/0075; A61J 9/00; B67B 3/20; A23L 33/30; A23V 2002/00

(57) ABSTRACT

The invention is directed to an absorbent neck ring for a baby bottle which is disc shaped with an aperture at the center. The ring is fitted to the bottle, preferably with elasticized cotton or other elastic fabric such that the aperture passes over the bottle opening and is secured below the screw fixtures when the cap is attached to the bottle. The ring ensures that any leaks from the bottle or the baby's mouth will be absorbed, rather than dripping on clothing or elsewhere. The ring may be laundered and re-used, or it may be used in a single use capacity. The ring may be provided in various colors and decorative configurations, such as an image of a teddy bear's face or a baseball.

### CROSS-REFERENCE TO RELATED APPLICATIONS

This Application claims the benefit of U.S. patent application Ser. No. 14/535,727 filed Nov. 7, 2014 which claimed the benefit of U.S. Provisional Application No. 61/901,636, filed Nov. 8, 2013, which are hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to infant care accessories and in particular to an absorbent neck ring for a baby bottle. The parents of infants, and those toddlers who are still bottle feeding, frequently face the problem of one or two drops of milk or formula trickling down their child's neck from the bottle. This may be due to a failure to completely seal the cap or the child's inability to retain and swallow all of the extracted milk or formula. These few drops of milk or formula are annoying, causing soiling and stains to the clothing of parent and child, as well as the upholstery of furniture and vehicles. Various protective measures, such as wrapping a washcloth around the bottle, have been attempted but these are less than elegant, and a better solution is sought by most parents. An absorbent neck ring for the bottle would resolve this problem. The ring is fitted to the bottle, preferably with elasticized cotton or other elastic fabric. The ring ensures that any leaks from the bottle or the baby's mouth will be absorbed, rather than dripping on clothing or elsewhere. The ring may be laundered and re-used, or it may be used in a single use capacity. The ring covers the bottle cap and provides a circular aperture at its center for the nipple to pass through. The ring may be provided in various colors and decorative configurations, such as an image of a teddy bear's face or a baseball.

### SUMMARY OF THE INVENTION

Accordingly, the invention is directed to an absorbent neck ring for a baby bottle. The ring is fitted to the bottle, preferably with elasticized cotton or other elastic fabric. The ring ensures that any leaks from the bottle or the baby's mouth will be absorbed, rather than dripping on clothing or elsewhere. The ring may be laundered and re-used, or it may be used in a single use capacity. The ring covers the bottle cap and provides a circular aperture at its center for the nipple to pass through. The ring may be provided in various colors and decorative configurations, such as an image of a teddy bear's face or a baseball.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate four embodiments of the invention and, together with the description, serve to explain the principles of the invention.

FIG. 1 is a front view of a bottle 12 with the cap 15 removed.

FIG. 2 is a front view of the ring 10 disposed on a bottle 12 with the cap 15 secured.

FIG. 3 is a top view of the first exemplary embodiment, displaying the ring 10A and the aperture 11.

FIG. 4 is a top view of the second exemplary embodiment, displaying the ring 10B and the aperture 11.

FIG. 5 is a top view of the third exemplary embodiment, displaying the abstract ring 10C, and aperture 11.

FIG. 6 is a top view of the fourth exemplary embodiment, displaying the ring 10D, and aperture 11.

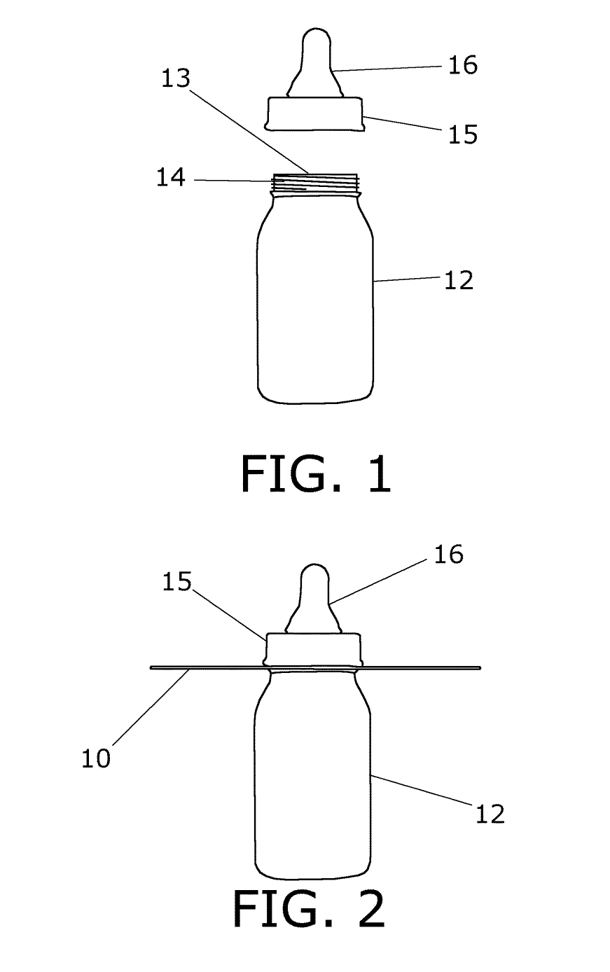

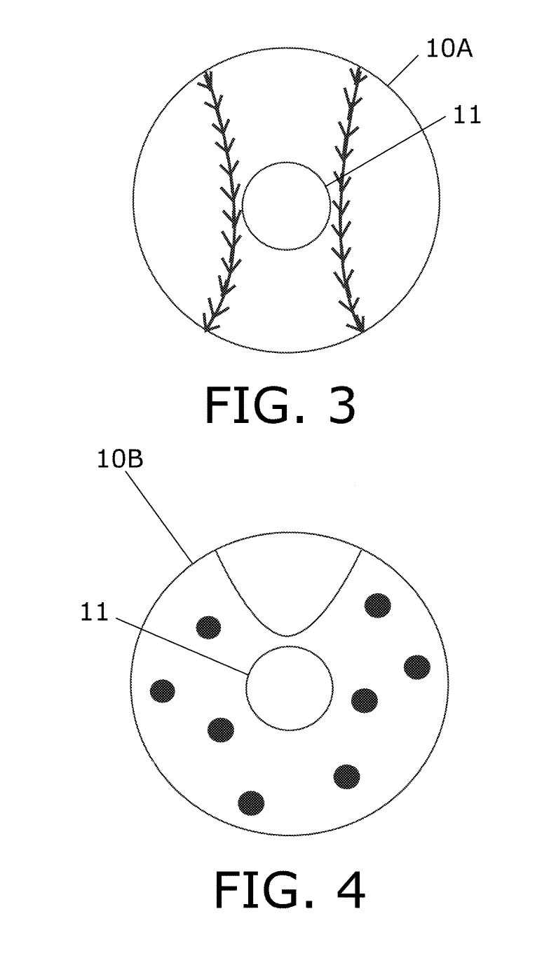

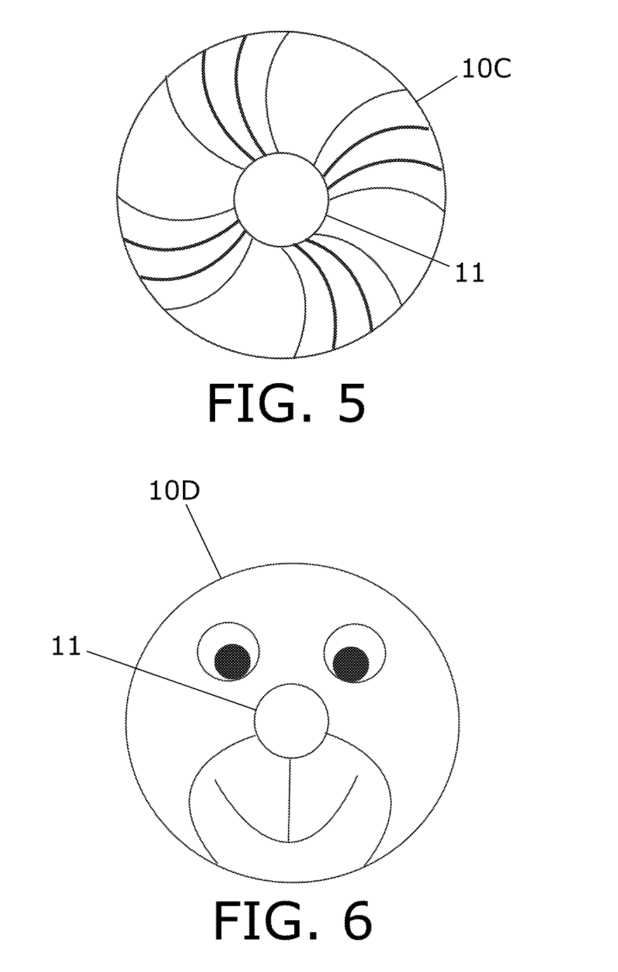

### DETAILED DESCRIPTION OF THE INVENTION

Referring now to the invention in more detail, the invention is directed to an absorbent neck ring 10A-10D for a baby bottle 12. The ring 10A-10D is fitted to the bottle 12, preferably with elasticized cotton or other elastic fabric. The ring 10A-10D ensures that any leaks from the bottle or the baby's mouth will be absorbed, rather than dripping on clothing or elsewhere. The ring 10A-10D may be laundered and re-used, or it may be used in a single use capacity. The ring 10A-10D is configured to be placed around the opening 13 to the bottle 12. The ring 10A-10D slides over the opening 13 below the screw fixtures 14 such that the cap 15 with nipple 16 secure the ring 10A-10D in place when attached to the bottle 12. The ring 10A-10D may be provided in various colors and decorative configurations, such as an image of a teddy bear's face or a baseball.

The ring 10A-10D is preferably a disc shape such that the ring 10A-10D is flat in that it is formed primarily on the same plane and no portion of the ring extends off of that plane. The outer edge 21 of the ring 10A-10D is equidistant from the center of the ring 10A-10D and has no appendages extending outwardly from the ring 10A-10D. The ring 10A-10D provides an aperture 11 at the center of the ring 10A-10D. The aperture forms an inner edge 20 of the ring 10A-10D. The inner edge 20 provides the elasticized portion of the ring 10A-10D such that the ring can be secured to the baby bottle 12.

The device is presented in four exemplary embodiments. The first exemplary embodiment features the decorative image of a baseball on the ring 10A. The second exemplary embodiment features the decorative image of a ladybug on the ring 10B. The third exemplary embodiment features an abstract decorative image on the ring 10C. The fourth exemplary embodiment features the decorative image of a teddy bear's face on the ring 10D.

To use any of the exemplary embodiments, the user places the ring 10A-10D on the bottle 12 by: removing the bottle cap 15; stretching the elastic down until the ring 10A-10D passes over the opening 13 and is secured below the screw fixtures 14; and attaching the bottle cap 15 with nipple 16 to the bottle 12 such that the bottle cap 15 and nipple 16 protrudes through the aperture 11. The bottle 10A-10D is then provided to the child for feeding.

The ring 10A-10D is preferably manufactured from a flexible, durable, highly absorbent fabric with elastic properties, such as terry cloth or elasticized cotton. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An absorbent neck ring for a baby bottle, comprising:
a. a ring having an aperture and being disc shaped such that the ring is flat and an outer edge is equidistant from the center of the ring with no appendages extending outwardly from the ring;
b. a bottle having an opening and a screw fixture;
c. a bottle cap having a nipple and being sized and shaped to attach to the bottle over and around the opening;
d. said ring and aperture being sized and shaped to securely fit over and around the opening and below the screw fixture such that the ring is secured in place when said bottle cap is attached to the bottle.

2. The absorbent neck ring for a baby bottle of claim 1, wherein said aperture forms an inner edge of the ring; said inner edge being elastic such that the inner edge can be stretched over the opening and secure around the opening below the screw fixture.

3. The absorbent neck ring for a baby bottle of claim 1, wherein said ring provides a decorative image of a baseball.

4. The absorbent neck ring for a baby bottle of claim 2, wherein said ring provides a decorative image of a baseball.

5. The absorbent neck ring for a baby bottle of claim 1, wherein said ring provides a decorative image of a ladybug.

6. The absorbent neck ring for a baby bottle of claim 2, wherein said ring provides a decorative image of a ladybug.

7. The absorbent neck ring for a baby bottle of claim 1, wherein said ring provides a decorative image of an abstract pattern.

8. The absorbent neck ring for a baby bottle of claim 2, wherein said ring provides a decorative image of an abstract pattern.

9. The absorbent neck ring for a baby bottle of claim 1, wherein said ring provides a decorative image of a teddy bear face.

10. The absorbent neck ring for a baby bottle of claim 2, wherein said ring provides a decorative image of a teddy bear face.

11. The absorbent neck ring for a baby bottle of claim 1, wherein said ring is made of a flexible, durable, and highly absorbent fabric.

12. The absorbent neck ring for a baby bottle of claim 2, wherein said ring is made of a flexible, durable, and highly absorbent fabric.

13. A method of use of the absorbent neck ring for a baby bottle of claim 1 comprising:
a. removing the bottle cap from the bottle;
b. stretching the inner edge of the ring such that the ring may pass over the opening and be secured below the screw fixtures;
c. attaching the bottle cap to the bottle such that the bottle cap and nipple protrude through the aperture on the ring;
d. feeding an infant with the bottle; and
e. cleaning and spills from the bottle with the ring.

14. A method of use of the absorbent neck ring for a baby bottle of claim 2 comprising:
a. removing the bottle cap from the bottle;
b. stretching the inner edge of the ring such that the ring may pass over the opening and be secured below the screw fixtures;
c. attaching the bottle cap to the bottle such that the bottle cap and nipple protrude through the aperture on the ring;
d. feeding an infant with the bottle; and
e. cleaning and spills from the bottle with the ring.

15. A method of use of the absorbent neck ring for a baby bottle of claim 11 comprising:
a. removing the bottle cap from the bottle;
b. stretching the inner edge of the ring such that the ring may pass over the opening and be secured below the screw fixtures;
c. attaching the bottle cap to the bottle such that the bottle cap and nipple protrude through the aperture on the ring;
d. feeding an infant with the bottle; and
e. cleaning and spills from the bottle with the ring.

16. A method of use of the absorbent neck ring for a baby bottle of claim 12 comprising:
a. removing the bottle cap from the bottle;
b. stretching the inner edge of the ring such that the ring may pass over the opening and be secured below the screw fixtures;
c. attaching the bottle cap to the bottle such that the bottle cap and nipple protrude through the aperture on the ring;
d. feeding an infant with the bottle; and
e. cleaning and spills from the bottle with the ring.
